(19) United States
(12) Patent Application Publication
(10) Pub. No.: US 2016/0041888 A1
(43) Pub. Date: Feb. 11, 2016

(54) LINK STATE RELAY FOR PHYSICAL LAYER EMULATION

(71) Applicant: BROCADE COMMUNICATIONS SYSTEMS, INC., San Jose, CA (US)

(72) Inventors: Srinivas S. Hanabe, Los Altos Hills, CA (US); Jitendra Verma, San Jose, CA (US); Eswara S. P. Chinthalapati, San Jose, CA (US)

(73) Assignee: BROCADE COMMUNICATIONS SYSTEMS, INC., San Jose, CA (US)

(21) Appl. No.: 14/919,553

(22) Filed: Oct. 21, 2015

Related U.S. Application Data
(62) Division of application No. 13/250,969, filed on Sep. 30, 2011.
(60) Provisional application No. 61/392,400, filed on Oct. 12, 2010.

(51) Int. Cl. G06F 11/20

(52) U.S. Cl. CPC G06F 11/2002; G06F 2201/805; G06F 2201/85

(57) ABSTRACT

One embodiment of the present invention provides a fault-management system. During operation, the system identifies a failure at a remote location associated with a communication service. The system then determines a local port used for the communication service, and suspends the local port, thereby allowing the failure to be detected by a device coupled to the local port.

### RELATED APPLICATIONS

This application is a divisional application of application Ser. No. 13/250,969, Attorney Docket Number BRCD-3067.1.US.NP, entitled “Link State Relay for Physical Layer Emulation,” by inventors Srinivas S. Hanabe, Jitendra Verma, and Eswara S. P. Chinthalapati, filed 30 Sep. 2011, which claims the benefit of U.S. Provisional Application No. 61/392,400, Attorney Docket Number BRCD-3067.0.1.US.PSP, entitled “LINK STATE RELAY FOR PHYSICAL LAYER EMULATION,” by inventors Srinivas S. Hanabe, Jitendra Verma, and Eswara S. P. Chinthalapati, filed 12 Oct. 2010, the disclosures of which are incorporated by reference herein.

### BACKGROUND

1. Field

The present disclosure relates to network management. More specifically, the present disclosure relates to fault detection and management in a communication network.

2. Related Art

Telecom service providers (SPs) often provide services to enterprise customers having multiple physical locations. For example, an SP can provide virtual leased line (VLL) services to a business customer to enable high-speed, reliable connectivity service between two separate sites of the customer. Conventionally, on the physical layer, the SP network is based on the synchronous optical networking (SONET) standard, and the edge devices are equipped with SONET equipment to provide SONET circuit(s) between customer edge (CE) points, which belong to the customer's own network. The provision of SONET circuits allows a local CE port to detect a failure in the provider network or in the corresponding remote CE port in a timely manner.

However, the price for optical equipment is high, and service providers are increasingly moving away from SONET solutions to Metro Ethernet solutions. Contrary to the SONET, in a packet-switched network, such as a multiprotocol label switching (MPLS) network or an Ethernet network, if the two endpoints are not directly coupled (for example, if they are located at two sides of the provider's network), link-level connectivity on their respective ports is not exchanged. Hence, if a remote CE port goes down, the local CE port stays alive and continues to forward traffic to the remote port. This can lead to significant traffic loss and extended network down time.

### SUMMARY

One embodiment of the present invention provides a fault-management system. During operation, the system identifies a failure at a remote location associated with a communication service. The system then suspends the local port used for that communication service, thereby allowing the failure to be detected by a device coupled to the local port. This significantly reduces network down time for the customer. In addition, since the customer's network is aware of the remote fault, it can take steps to re-route traffic through another network if such a backup network has been provisioned.

In a variation on this embodiment, suspending the local port includes placing the local port in a special down state and maintaining state information for the local port.

In a variation on this embodiment, identifying the failure comprises processing a message generated by a remote switch indicating the failure.

In a further variation, the message is a connectivity fault management message.

In a variation on this embodiment, the system detects a recovery from the failure and resumes operation on the suspended local port, thereby allowing the device coupled to the local port to resume transmission.

In a variation on this embodiment, the system detects a local failure. The system then generates a message indicating the local failure, and transmits the message to a remote switch, thereby allowing the remote switch to suspend a port on the remote switch.

In a variation on this embodiment, the communication service includes at least one of: a virtual local area network (VLAN) service; a virtual private LAN service (VPLS); a virtual private network (VPN) service; and a virtual leased line (VLL) service.

### BRIEF DESCRIPTION OF THE FIGURES

FIG. 1 presents a diagram illustrating an exemplary scenario where two endpoints are coupled via a provider network.

FIG. 2A presents a diagram illustrating an exemplary connectivity fault management (CFM) protocol data unit (PDU).

FIG. 2B presents a diagram illustrating details of the CFM frame data field.

FIG. 2C presents a diagram illustrating the format of the Interface Status TLV, in accordance with one embodiment of the present invention.

FIG. 2D presents a diagram illustrating the mapping between the value field of the Interface Status TLV and the interface status, in accordance with one embodiment of the present invention.

FIG. 3 presents a diagram illustrating the architecture of a network that is capable of physical port emulation, in accordance with an embodiment of the present invention.

FIG. 4 presents a diagram illustrating the architecture of a network that is capable of physical port emulation, in accordance with an embodiment of the present invention.

FIG. 5A presents an exemplary state diagram illustrating the process of bringing down a local port in response to a remote port failure, in accordance with an embodiment of the present invention.

FIG. 5B presents an exemplary state diagram illustrating the process of bringing up a local port in response to a remote port failure being resolved, in accordance with an embodiment of the present invention.

FIG. 6 presents a diagram illustrating an exemplary finite state machine (FSM) design in accordance with an embodiment of the present invention.

FIG. 7 provides a diagram illustrating the structure of a provider edge device that enables physical layer emulation, in accordance with an embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

Overview

In embodiments of the present invention, the problem of fast failure notification between two customer edge (CE) devices coupled via a packet-switched provider network is solved by allowing two provider edge (PE) devices in the packet-switched network to exchange connectivity check messages (CCMs) in the event of failure. Once a local PE device receives a CCM indicating a failure of a remote port or link, the local PE device suspends a corresponding local PE port. Consequently, the CE device coupled to the suspended local PE port can take proper actions, such as protection switching, to recover from the remote failure. When the remote port or link recovers, the local PE port can be brought back up accordingly. This significantly reduces network down time for the customer. In addition, because the customer's network is aware of the remote failure, the customer network can re-route its traffic through another network if such a backup network has been provisioned.

In this disclosure, the term “switch” refers to a network switching device capable of forwarding packets. A switch can be an MPLS router, an Ethernet switch, or any other type of switch that performs packet switching. Furthermore, in this disclosure, “router” and “switch” are used interchangeably.

The term “provider edge” or “PE” refers to a device located at the edge of a provider's network and which offers ingress to and egress from the provider network. The term “customer edge” or “CE” refers to a device located at the edge of a customer's network. A PE device is typically coupled to a CE device. When two CE devices communicate via a provider's network, each CE device is coupled to a respective PE device.

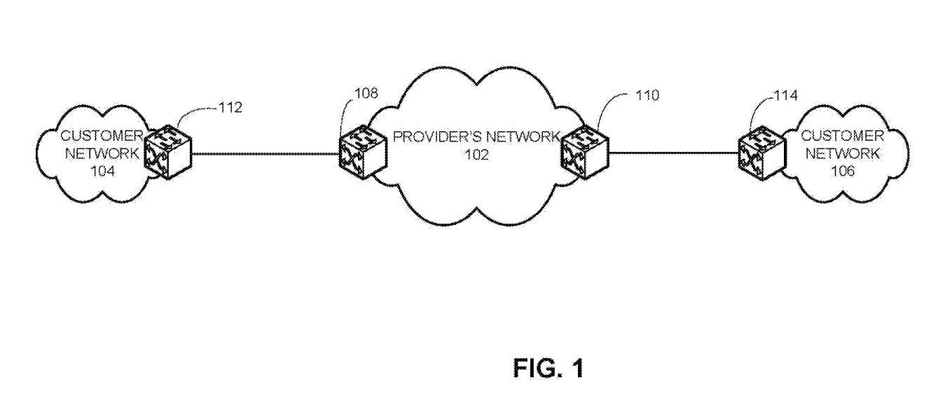

FIG. 1 presents a diagram illustrating an exemplary scenario where two endpoints are coupled via a provider network. As illustrated in FIG. 1, a provider's network 102 provides connectivity services to a business customer's networks 104 and 106. PE routers 108 and 110 interface with CE routers 112 and 114, respectively. Note that, in FIG. 1, CE routers 112 and 114 are not coupled to each other directly.

Various services, including but not limited to: virtual local area network (VLAN), virtual private LAN service (VPLS), virtual private network (VPN), and virtual leased line (VLL), can be provided to allow customer network 104 to communicate with customer network 106. To avoid traffic loss, it is desirable for the local CE port running a service to be aware of the health of the corresponding port at the remote side. For example, when a remote CE port for the VLL service fails while the corresponding local CE port stays alive, if the local CE port is unaware of the failure of the remote CE port, the local CE port will continue to forward VLL traffic to the remote CE port. This leads to traffic loss and increases the time required for network convergence. To avoid this situation, service providers need to provide their customers with a solution for physical layer emulation between two endpoints. Note that “physical layer emulation” as described herein refers to the scenario where the remote port status is reflected at the local network device.

In a conventional SONET based provider's network, such failure notification between two CE endpoints can be easily achieved because optical equipment at the PE routers of the provider's network can map the CE endpoints to specific wavelength channel(s) between these PE routers. However, this solution is expensive due to the high price of SONET equipment. Embodiments of the present invention provide a solution that allows MPLS, Ethernet, or other types of packet switching-based providers to offer the same physical layer emulation with fast failure notification as the SONET providers.

In one embodiment, physical level emulation across the packet-switched provider's network is achieved by extending an OAM (Operations, Administrations, and Maintenance) solution, such as Connectivity Fault Management (CFM) defined in IEEE Standard 802.1ag, available at http://www.ieee802.org/1/pages/802.1ag.html, which is incorporated by reference herein.

CFM allows service providers to manage each customer service instance, or Ethernet Virtual Connection (EVC), individually. In other words, CFM provides the ability to monitor the health of an end-to-end service delivered to customers as opposed to just links or individual bridges. In embodiments of the present invention, PE devices operate as maintenance endpoints (MEP) and issue connectivity check messages (CCMs) periodically. This allows MEPs to detect loss of service connectivity amongst themselves. However, it is still a challenge to solve the problem where a failure of an EVC or a remote port does not translate into a link status event at the local CE device. Embodiments of the present invention solve this problem by enabling the MEPs to continue issuing CCMs even after the EVC has failed due to the failure of a port or link on the CE device. A modified CCM is sent from a remote MEP (i.e., a remote PE device) to the local MEP (i.e., a local PE device), notifying the local MEP of a port failure on the CE device coupled to the remote MEP. Once the local MEP receives the modified CCM, the local MEP temporarily suspends a local port associated with the CCM session. Note that this solution can provide a very short reaction time (in the order of milliseconds) for discovering the remote port failures. In one embodiment, the reaction time for discovering a remote port failure is determined by the interval between the periodically sent CCMs, which can be less than 1 second. In a further embodiment, the reaction time is approximately 3.3 ms.

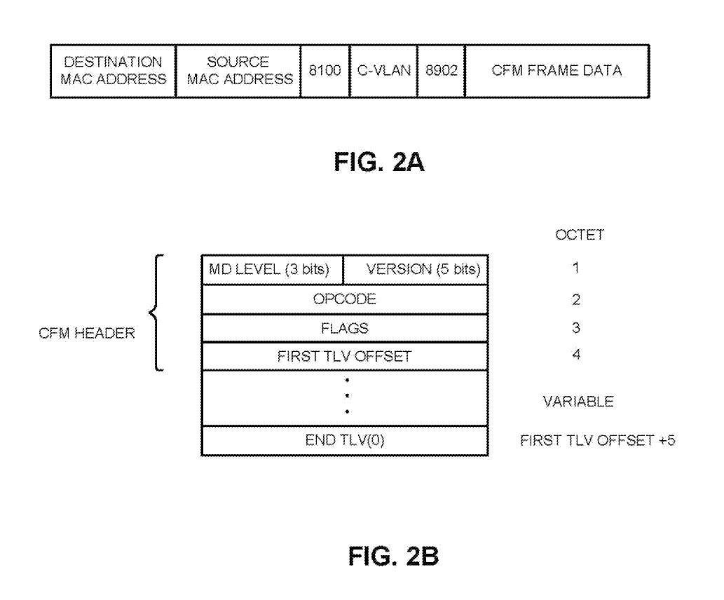

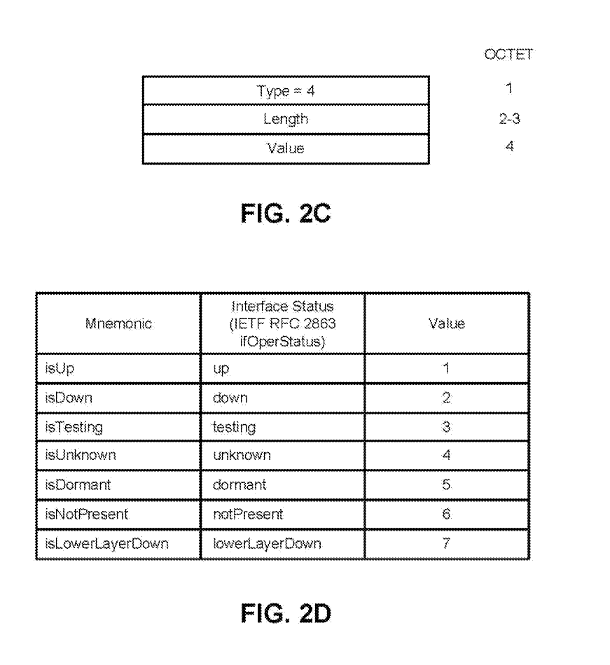

FIG. 2A presents a diagram illustrating an exemplary CFM protocol data unit (PDU). Note that CFM employs regular Ethernet frames, and hence can travel in-band with customer traffic. Devices that cannot interpret CFM messages forward them as normal data frames. Similarly to a regular Ethernet frame, a CFM PDU includes a destination media-access-control (MAC) address field, a source MAC address field, an outer Ethertype field (8100, identifying this frame as a VLAN-tagged frame), a customer-VLAN (C-VLAN) ID, an inner EtherType field (8902, identifying this frame as a CFM frame), and a CFM frame data field.

FIG. 2B presents a diagram illustrating details of the CFM Frame Data field. The beginning 4 octets (octets 1 through 4) constitute the common CFM header. The most-significant 3 bits of the first octet are the maintenance domain (MD) level field, which identifies the MD level of the frame. The least-significant 5 bits identifies the protocol version number. The OpCode field occupies 1 octet, and specifies the format and meaning of the remainder of the CFM PDU. The OpCode assigned for the CCM is 1.

The subsequent flags field is defined separately for each OpCode. For CCM, the flags field is split into three parts: a Remote Defect Indication (RDI) field, a reserved field, and a CCM interval field. The most-significant bit of the flags field is the RDI field. The following four bits are the reserved field. The least-significant three bits of the flags field constitute the CCM interval field, which specifies the transmission intervals of the CCMs. For example, if the transmission interval is 3.3 ms, the CCM interval field is set as 1.

The first TLV offset field of the common CFM header specifies the offset, starting from the first octet following the first TLV offset field, up to the first TLV in the CFM PDU. The value of the offset varies for different OpCodes. The first TLV offset field in a CCM is transmitted as 70.

In one embodiment, one of the TLVs can be used to indicate the status of the interface on which the MEP transmitting the CCM is configured (which is not necessarily the interface on which it resides) or the next lower interface as defined in IETF RFC 2863 (available at http://tools.ietf.org/html/rfc2863, which is incorporated by reference herein). This TLV can be referred to as an Interface Status TLV. FIG. 2C presents a diagram illustrating the format of the Interface Status TLV. The first octet of the Interface Status TLV is the type filed, which is 4. The length field occupies two octets, and the fourth octet is the value field. FIG. 2D presents a diagram illustrating the mapping between the value field of the Interface Status TLV and the interface status defined in IETF RFC 2863.

A number of CCM-specific fields (not shown in FIG. 2B), such as a sequence number field, a maintenance association endpoint identifier field, a maintenance association identifier field, and other optional TLV fields, are also included in the CCM message.

The status of a remote port can propagate across a provider network (even if the provider network includes multiple networks maintained by different administrative organizations) using CCM transmitted between two MEPs. Once a local MEP is notified of a remote port failure, a corresponding local PE port coupled to the CE equipment is suspended, which allows the CE equipment to be notified of the failure and to avoid significant traffic loss. In one embodiment, an external network-management system can be used to facilitate the process of bringing down the local port, and maintaining the status of all ports.

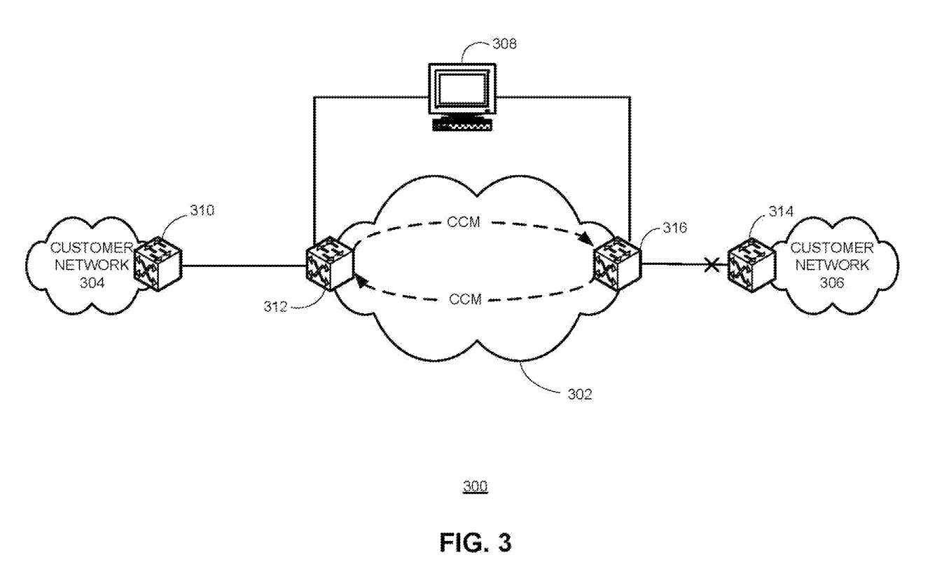

FIG. 3 presents a diagram illustrating the architecture of a network that is capable of physical port emulation, in accordance with an embodiment of the present invention. A physical-port-emulation-enabled network 300 includes a provider network 302, customer networks 304 and 306, and an external network-management server 308. Customer network 304 communicates with customer network 306 via provider network 302, which includes a PE device 312 facing customer network 304 and a PE device 316 facing customer network 306. In one embodiment, provider network 302 is a multiprotocol label switching (MPLS) network. Customer network 304 includes a CE device 310, which is coupled to PE device 312, and customer network 306 includes a CE device 314, which is coupled to PE device 316. Network-management server 308 is coupled to PE devices 312 and 316.

During operation, local PE device 312 and remote PE device 316 function as MEPs for service provider network 302, and periodically exchange CCMs (shown by the dashed lines), which provide a means to detect connectivity failures. In addition, PE devices 312 and 316 can detect any port failure on the coupled CE devices (or link failures), and report the port-down information to network-management server 308. For example, if there is a port failure on CE device 314 (for example, a port running the VLL service for customer network 306 failed), PE device 316 will notify network-management server 308 of this port failure. To prevent significant traffic loss (e.g., to prevent a port on CE device 310 from forwarding traffic to the failed port on CE device 314), network-management server 308 maps this failure to a corresponding port (via user configurations) on PE device 312, and triggers an event (such as a “VLL port down” event) on PE device 312 to temporarily suspend that corresponding port on PE device 312. This operation allows CE device 310 to detect the failure and divert the traffic to an alternative path by using protective switching. In addition, network-management server 308 stores all port states and appropriate event transitions. Note that this held-down port is maintained at a special state that is different from other “port down” state because the port itself is actually functioning. As soon as the failed port on the remote end recovers, network-management server 308 can bring up the held-down port to resume traffic, thus significantly reducing the network recovery time.

The solution shown in FIG. 3 relies on an external network-management server to bring down a local endpoint in response to the failure of a remote endpoint. Although this solution can be supported by existing network-management systems, such as a Brocade Network Advisor (BNA), creating an interface between an existing network-management system and various types of PE and CE devices may be a challenge. To solve this problem, in one embodiment, the task of bringing down a port is handled by the PE devices.

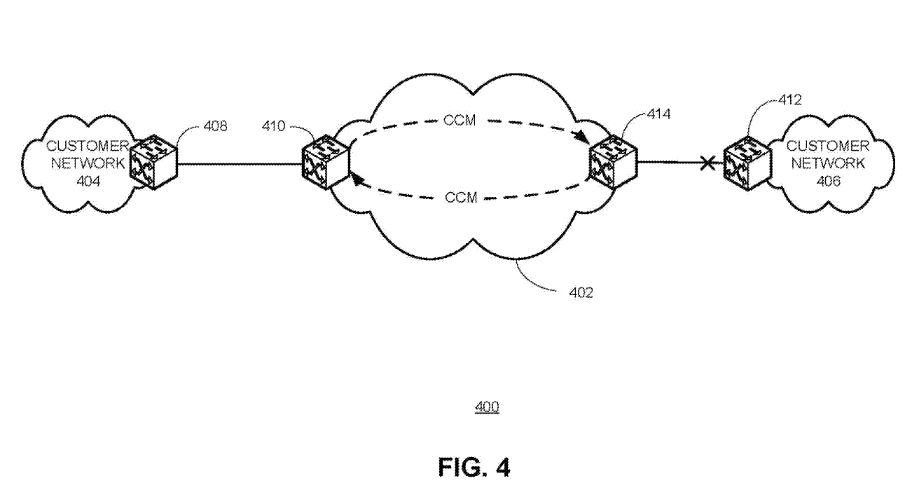

FIG. 4 presents a diagram illustrating the architecture of a network that is capable of physical port emulation, in accordance with an embodiment of the present invention. In FIG. 4, a physical-port-emulation-enabled network 400 includes a provider network 402 and customer networks 404 and 406. Customer network 404 communicates with customer network 406 via provider network 402, which includes a PE device 410 facing customer network 404 and a PE device 414 facing customer network 406. Customer network 404 includes a CE device 408, which is coupled to a PE device 410, and customer network 406 includes a CE device 412 which is coupled to a PE device 414.

The operation of network 400 is similar to that of network 300, except that, without an external network-management server, the PE devices are responsible for bringing down a local port in response to a remote port failure. During operation, local PE device 410 and remote PE device 414 periodically exchange CCMs. When a PE device detects a failure (which can be a CE port failure, a link failure, or a PE port failure) at one end of a service instance, the PE device sends a CCM to a corresponding PE device at the other end of the service instance, notifying the corresponding PE device of the failure. The corresponding PE device maps the failure to a local PE port coupled to a customer port associated with the service instance at this end, and brings down the mapped local PE port to prevent the coupled customer port from forwarding traffic to the failed port. For example, in FIG. 4, if a VLL port on CE device 412 fails, PE device 414 detects this failure, generates a CCM that indicates the failure, and sends the CCM to PE device 410. In one embodiment, the RDI bit of the CCM is set to indicate an interface failure. Note that, to do so, specific configuration of the PE devices may be needed to restrict the use of the RDI bit to reporting remote failure only. In a further embodiment, the failure is expressed by the Interface Status TLV value. More specifically, the Interface Status TLV value can be set as “2” to indicate the interface status as “down.” The interface failure can also be indicated by setting one bit of the reserved field, which is included in the flags field of the CFM header (see FIG. 2B). PE device 410 receives the CCM, maps the failed VLL port to a local port coupled to CE device 408, and puts this mapped port in a special “down” state. Since the link is held down, CE device 408 detects the link down and prevents a corresponding port on CE device 408 from sending traffic to the failed port on CE device 412. CE device 408 may also re-route the traffic through a backup network if such network has been previously configured. In addition, PE device 410 maintains the status of the local VLL port in this special “down” state. Once the failed port on CE device 412 recovers, PE device 414 generates a new CCM that indicates the port status as up. In one embodiment, the CCM is generated by clearing its RDI bit. In a further embodiment, the CCM is generated by setting the value field of the Interface Status TLV to “1,” indicating the interface status as “up.” When PE device 410 receives a CCM with a cleared RDI bit, PE device 410 immediately brings up the VLL port that is held in the special “down” state, and the VLL service between customer networks 404 and 406 can be resumed.

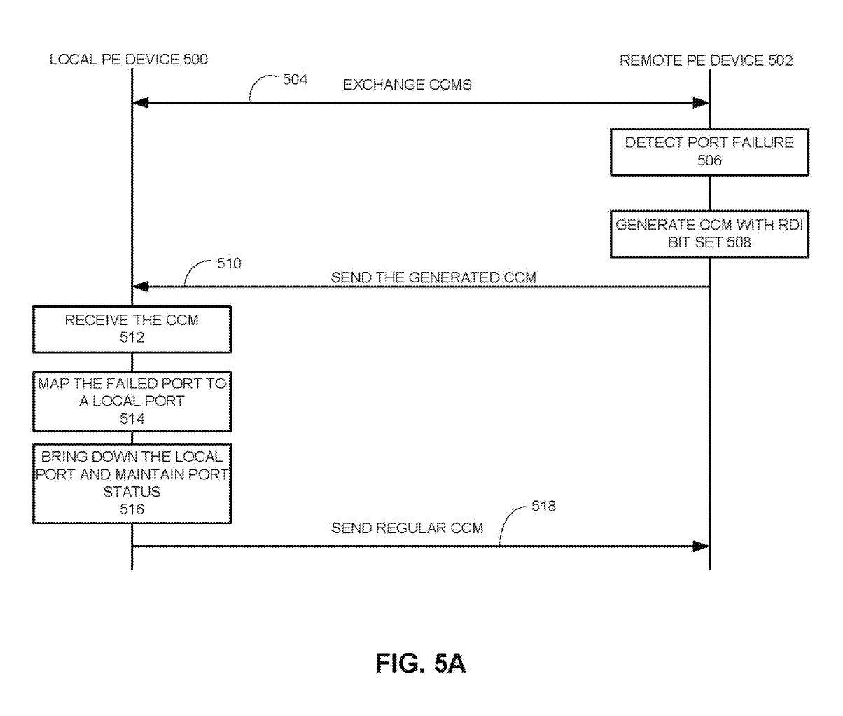

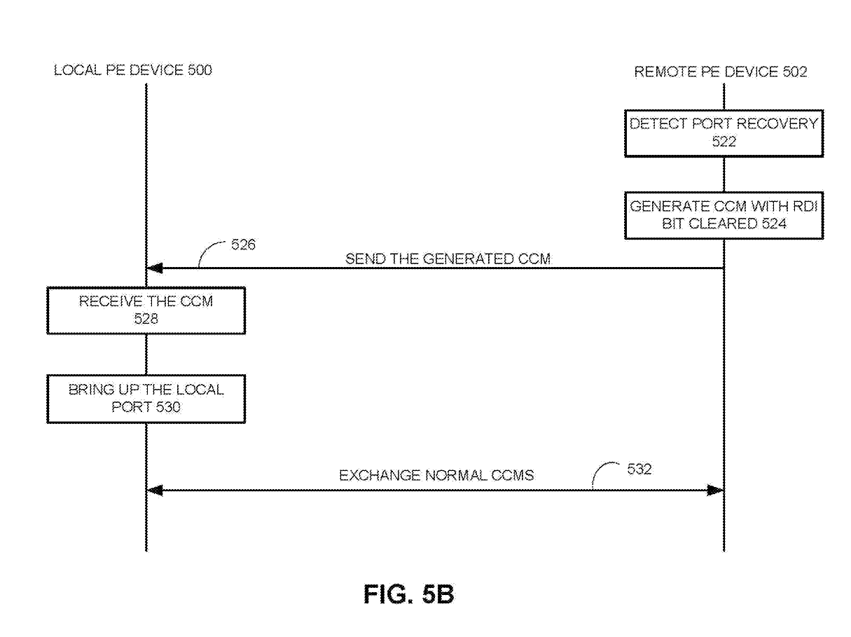

FIG. 5A presents an exemplary state diagram illustrating the process of bringing down a local port in response to a remote port failure, in accordance with an embodiment of the present invention. During normal operation, a local PE device 500 and a remote PE device 502 on either end of a service exchange CCMs (operation 504). Note that the reception of a normal CCM ensures one end that the other end is functioning normally. When remote PE device 502 detects a failure, which can be a CE port failure, a PE port failure, or a link failure, on a coupled port (operation 506), it generates a port-failure-report CCM (operation 508). In one embodiment, the port-failure-report CCM is generated by setting the RDI bit in the CCM. In a further embodiment, the port-failure-report CCM is generated by setting the value field of the Interface Status TLV to “2,” indicating the interface status as “down.” Remote PE device 502 then sends the generated CCM with its RDI bit set to local PE device 500 (operation 510).

Local PE device 500 receives the port-failure-report CCM, either with its RDI bit set or with its Interface Status TLV value set as “2” (operation 512), and maps the failure to a local PE port facing the CE equipment and associated with the service (operation 514). Subsequently, local PE device 500 brings down the local PE port and maintains its port status (operation 516). In one embodiment, the local PE port is kept in a special “down” state, which is different from other “down” states, such as the one caused by local equipment failures. The link is still brought down in the special “down” state just as in other down states. Local PE device 500 continues to send regular CCMs to remote PE device 502 (operation 518).

FIG. 5B presents an exemplary state diagram illustrating the process of bringing up a local port in response to a remote port failure being resolved, in accordance with an embodiment of the present invention. During operation, remote PE device 502 detects that the failed port has recovered (operation 522), and generates an interface-up CCM by clearing its RDI bit or by resetting its Interface Status TLV value to “1” (operation 524). Remote PE device 502 then sends the generated interface-up CCM to local PE device 500 (operation 526). Local PE device 500 receives the interface-up CCM (operation 528), and in response, brings up the port that was originally placed in the special “down” state (operation 530). Subsequently, normal CCMs are exchanged between local PE device 500 and remote PE device 502 (operation 532), and communications between the local port and the remote port can be resumed.

In some cases, CCMs may fail to reach an MEP. For example, a one-direction path failure may occur between a local MEP and a remote MEP, resulting in CCMs from the local MEP not reaching the remote MEP. The remote MEP, which fails to receive regular CCMs from the local MEP, can detect the CCM failure, and in response, send failure-report CCMs with RDI bit set or with the Interface TLV value set as “2” to the local MEP. In addition, the remote MEP brings down a coupled port associated with the CCM session by placing the coupled port in a special “down” state. The local MEP, in response to receiving the failure-report CCMs, also brings down a local port associated with the CCM session by placing the local port in a special “down” state. Although the CCM failure occurs in one direction (from the local MEP to the remote MEP), ports at both ends are put into the special “down” state.

While the ports are down, the remote MEP continues to send failure-report CCMs to the local MEP. The local MEP also attempts to send regular CCMs. Once the CCM path between the two MEPs is recovered, the remote MEP starts to receive regular CCMs sent by the local MEP. In response to receiving CCMs with cleared RDI bit or with the Interface Status TLV value set as “1,” the remote MEP brings up the coupled port that was in the special “down” state. In addition, the remote MEP generates interface-up CCMs by reseting the RDI bit or by setting the Interface Status TLV value as “1,”, and sends these interface-up CCMs to the local MEP. In response to receiving these interface-up CCMs, the local MEP brings up the corresponding port on its end, and normal communication between the local port and the remote port resumes.

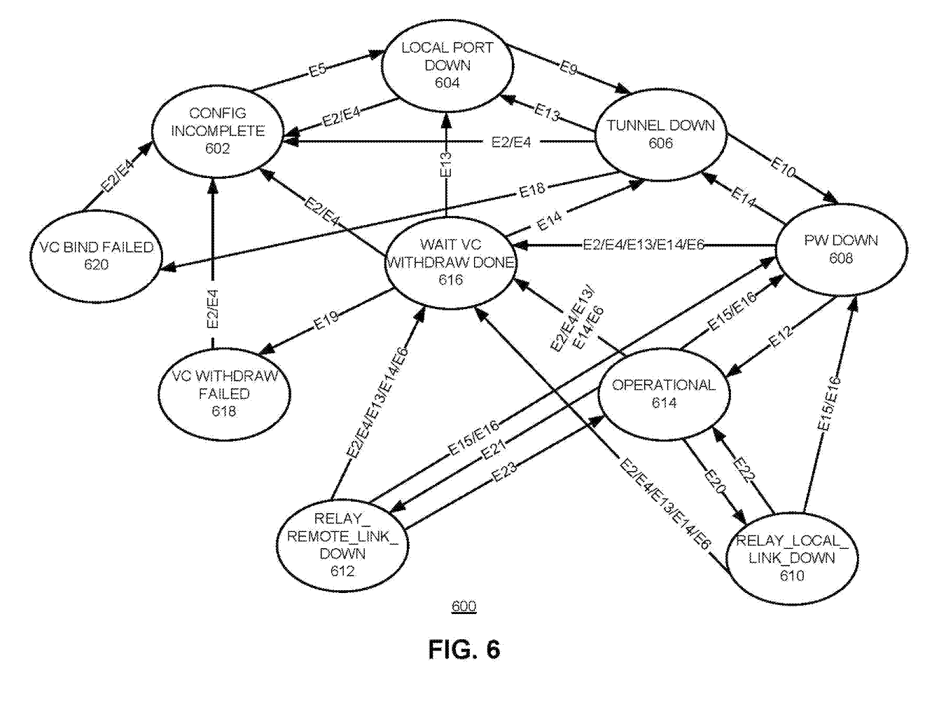

FIG. 6 presents a diagram illustrating an exemplary finite state machine (FSM) design in accordance with an embodiment of the present invention. FSM 600 includes 10 states: a configuration-incomplete state 602, a local-port-down state 604, a tunnel-down state 606, a pseudowire (PW)-down state 608, a relay-local-link-down state 610, a relay-remote-link-down state 612, an operational state 614, a wait-virtual-channel (VC)-withdraw-done state 616, a VC-withdraw-failed state 618, and a VC-bind-failed state 620.

FSM 600 also includes a number of events, where certain events trigger a transition between states. The following is a list of events in FSM 600:

E1: ENDPOINT_ADD

E2: ENDPOINT_DELETE

E3: PEER_ADD

E4: PEER_DELETE

E5: CONFIG_COMPLETE

E6: VC_PARAM_UPDATE

E7: INSTANCE_DELETE

E8: NO_ROUTER_MPLS

E9: ENDPOINT_UP

E10: TUNNEL_UP

E11: LDP_SESSION_UP

E12: PW_UP

E13: ENDPOINT_DOWN

E14: TUNNEL_DOWN

E15: LDP_SESSION_DOWN

E16: PW_DOWN

E17: VC_WITHDRAW_DONE

E18: VC_BIND_FAILED

E19: VC_WITHDRAW_FAILED

E20: LINK_RELAY_LOCAL_DOWN

E21: LINK_RELAY_REMOTE_DOWN

E22: LINK_RELAY_LOCAL_UP

E23: LINK_RELAY_REMOTE_UP

Various events lead to the various state transitions are illustrated in FIG. 6. For example, when FSM 600 is in configuration-incomplete state 602, it is waiting for the configuration to be completed. While waiting, FSM 600 stays in configuration-incomplete state 602 and ignores all events. If E5 (CONFIG_COMPLETE) occurs, FSM 600 transits to local-port-down state 604, at which FSM 600 waits for endpoint to come up. While in local-port-down state 604, if E2 (ENDPOINT_DELETE) or E4 (PEER_DELETE) occurs, FSM 600 moves back to configuration-incomplete state 602. If E9 (ENDPOINT_UP) occurs, FSM 600 transits to tunnel-down state 606, at which FSM 600 waits for the tunnel to come up. While in tunnel-down state 606, if E2 or E4 occurs, FSM 600 returns to configuration-incomplete state 602; if E13 (ENDPOINT_DOWN) occurs, FSM 600 moves back to local-port-down state 604. If E10 (TUNNEL_UP) occurs, a VC binding request is issued. If the VC binding fails due to withdraw pending, FSM 600 moves to wait-VC-withdraw-done state 616, and the next state is tunnel-down state 606. If E18 (VC_BIND_FAILED) occurs (VC binding fails due to resource allocation failure), FSM 600 moves to VC-bind-failed state 620. User intervention is needed to come out of VC-bind-failed state 620. Otherwise, FSM 600 transits to PW-down state 608, at which FSM 600 waits for the PW to come up.

While in PW-down state 608, if E2/E4/E13/E14 (TUNNEL_DOWN)/E6 (VC_PARAM_UPDATE) occurs, a VC withdrawal command is issued, and FSM 600 changes the state to wait-VC-withdraw-done state 616. The withdraw-next-state will be: configuration-incomplete state 602 if E2/E4 occurs, local-port-down state 604 if E13 occurs, or tunnel-down state 606 if E14 or E6 occurs. If E12 (PW_UP) occurs, FSM 600 moves from PW-down state 608 to operational state 614 where the PW is completely operational.

While in operational state 614, if E2/E4/E13/E14/E6 occurs, a VC withdrawal command is issued, and FSM 600 changes the state to wait-VC-withdraw-done state 616. The withdraw-next-state will be: configuration-incomplete state 602 if E2/E4 occurs, local-port-down state 604 if E13 occurs, or tunnel-down state 606 if E14 or E6 occurs. If E15 (LDP_SESSION_DOWN) or E16 (PW_DOWN) occurs, FSM 600 moves from operational state 614 to PW-down state 608, and no withdrawal is issued.

The aforementioned state transitions do not include state transitions associated with link state relay. Compared with a regular FSM not implementing link relay, FSM 600 includes two link-relay states (relay-local-link-down state 610 and relay-remote-link-down state 612). When a local link (a local port coupled to the MEP) goes down (E20), FSM 600 moves to relay-local-link-down state 610 from operational state 614, and all tunnel label and VC label information remains intact. The MEP sends a failure-report message to a remote MEP indicating this endpoint-link down event by setting the RDI bit of the CCMs or by setting the Interface Status TLV value as “1.” Note that the service between the two MEPs remains operationally active to allow transmission of CCMs. When the remote MEP receives a failure-report CCM, the FSM running on the remote MEP will move from operational state 614 to a relay-remote-link-down state 612. The remote MEP also brings down the endpoint interface. The VC/tunnel label information remains intact so that the CCM packets can still flow to the local MEP.

When the local link comes up (E22), the local MEP sends interface-up CCMs to the remote MEP, indicating the link up state by clearing the RDI bit of the CCMs or by setting the Interface Status TLV value as “1.” At the local MEP, FSM 600 moves from relay-local-link-down state 610 back to operational state 614. This also reprograms its content-addressable memory (CAM) or the phase-change memory (PRAM) so that the endpoint traffic can flow through using the link relay PW.

The remote MEP receives the interface-up CCMs that indicate the endpoint link up event (E23), and its own FSM will move from relay-remote-link-down state 612 to operational state 614. This will eventually reprogram its content-addressable memory (CAM) or the phase-change memory (PRAM) so that the endpoint traffic can be sent quickly.

Since the CCMs reach the other end even before the endpoint is enabled on the local MEP, the endpoint on the remote MEP can be brought up quickly enough so that traffic from the endpoint coupled to the local MEP using the link relay can be forwarded to the endpoint coupled to the remote MEP. This failover can be achieved in the time scale of milliseconds.

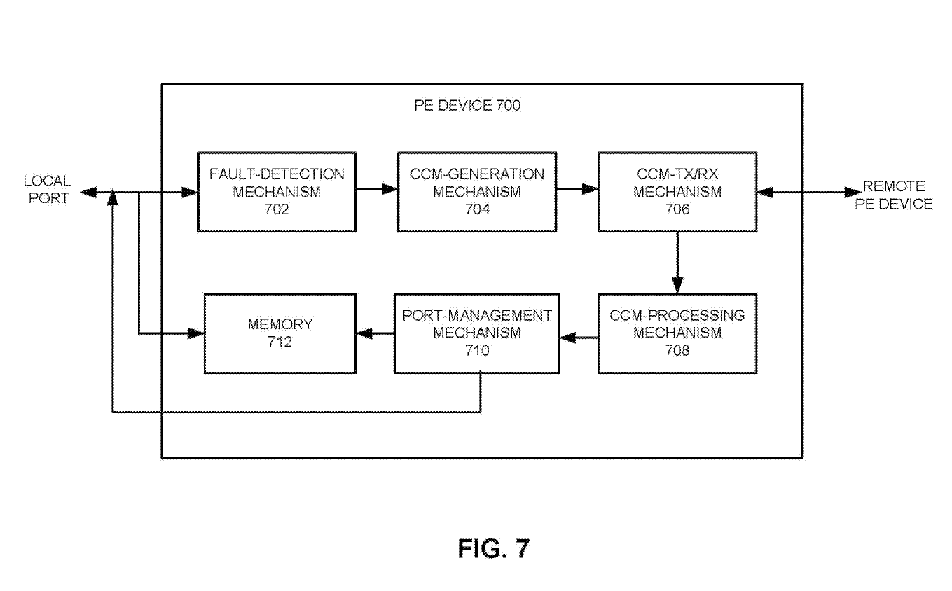

FIG. 7 provides a diagram illustrating the structure of a provider edge device that enables physical layer emulation, in accordance with an embodiment of the present invention. Provider edge (PE) device 700 includes a fault-detection mechanism 702, a CCM-generation mechanism 704, a CCM-transmitting/receiving (TX/RX) mechanism 706, a CCM-processing mechanism 708, a port-management mechanism 710, and a memory 712.

Fault-detection mechanism 702 is configured to detect faults in a port coupled to PE device 700. CCM-generation mechanism 704 is configured to generate CCMs. During normal operation, CCM-generation mechanism 704 generates regular CCMs, indicating that no fault has been detected. When fault-detection mechanism 702 detects a local failure, CCM-generation mechanism 704 generates failure-report CCMs with their RDI bit set or with their Interface Status TLV value set as “2,” indicating a failure at this end. CCM TX/RX mechanism 706 is configured to periodically transmit and receive CCMs to and from a remote PE device.

When CCM-TX/RX mechanism 706 receives a CCM, it sends the received CCM to CCM-processing mechanism 708, which is configured to process the received CCM by examining the RDI bit or by examining the value field of the Interface Status TLV. If CCM-processing mechanism 708 determines that the RDI bit of an incoming CCM is set or the Interface Status TLV is set as “2” (down), it notifies port-management mechanism 710, which in response brings down a corresponding coupled local port to prevent it from forwarding traffic to the failed remote port. The coupled port is now placed in a special “down” state to enable subsequent fast recovery. In addition, port states and event transitions associated with the local port is maintained in memory 712. Note that while the coupled port is in the special “down” state, CCM-TX/RX mechanism 706 continues to transmit regular CCMs to the remote PE device. Subsequently, if CCM-processing mechanism 708 determines that the RDI bit of a newly received CCM is cleared or the Interface Status TLV is reset as “1” (up), it notifies port-management mechanism 710, which in response brings up the port that was held in a special “down” state.

Note that embodiments of the present invention provide a solution that a packet-switched network to provide physical layer emulation capability to their customers. Compared with the SONET solution, the present solutions are more cost effective. This solution expands upon the existing Ethernet CFM standard, which uses CFM messages to detect and report connectivity failures. Unlike conventional fault-management mechanisms, in embodiments of the present invention, a number of “physical actions” are linked to CFM events. Note that these physical actions (including bringing down a port in response to a remote port failure and bringing up the port when the remote port recovers) are not defined in the CFM standard.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A computer-executed method, comprising:
identifying, by a computing system, a first failure to receive a first connectivity check message associated with a session between the computing system and a remote device;
generating a second connectivity check message that indicates the first failure and is destined for the remote device;
in response to identifying the first failure, suspending a first port, wherein the first port is a local port associated with the session;
in response to identifying a third received connectivity check message associated with the session from the remote device, resuming operation on the suspended first port; and
generating a fourth connectivity check message that indicates a recovery from the first failure and is destined for the remote device.

2. The method of claim 1, wherein suspending the first port comprises:
placing the first port in a special down state; and
maintaining state information for the first port.

3. The method of claim 1, wherein identifying the first failure comprises processing a message generated by a remote switch indicating the first failure.

4. The method of claim 3, wherein the message is a connectivity fault management message.

5. The method of claim 1, further comprising:
in response to suspending the first port, generating a plurality of second connectivity check messages that indicate the first failure and are destined for the remote device.

6. The method of claim 1, further comprising:
identifying a second failure at the remote device, wherein the second failure is associated with a second port which faces a destination node of a communication service;
mapping a third port of the computing system to the second failure, wherein the third port is a local port which faces a source node of the communication service; and
suspending the third port in response to identifying the second failure at the remote device.

7. The method of claim 6, wherein the communication service includes at least one of:
a virtual local area network (VLAN) service;
a virtual private LAN service (VPLS);
a virtual private network (VPN) service; and
a virtual leased line (VLL) service.

8. A non-transitory computer-readable storage medium storing instructions which when executed by a computer cause the computer to perform a method, the method comprising:
identifying a first failure to receive a first connectivity check message associated with a session between a computing system and a remote device;
generating a second connectivity check message that indicates the first failure and is destined for the remote device;
in response to identifying the first failure, suspending a first port, wherein the first port is a local port associated with the session;
in response to identifying a third received connectivity check message associated with the session from the remote device, resuming operation on the suspended first port; and
generating a fourth connectivity check message that indicates a recovery from the first failure and is destined for the remote device.

9. The computer-readable storage medium of claim 8, wherein suspending the first port comprises:
placing the first port in a special down state; and
maintaining state information for the first port.

10. The computer-readable storage medium of claim 8, wherein identifying the first failure comprises processing a message generated by a remote switch indicating the first failure.

11. The computer-readable storage medium of claim 10, wherein the message is a connectivity fault management message.

12. The computer-readable storage medium of claim 8, wherein the method further comprises:
in response to suspending the first port, generating a plurality of second connectivity check messages that indicate the first failure and are destined for the remote device.

13. The computer-readable storage medium of claim 8, wherein the method further comprises:
identifying a second failure at the remote device, wherein the second failure is associated with a second port which faces a destination node of a communication service;
mapping a third port of the computing system to the second failure, wherein the third port is a local port which faces a source node of the communication service; and
suspending the third port in response to identifying the second failure at the remote device.

14. The computer-readable storage medium of claim 13, wherein the communication service includes at least one of:
a virtual local area network (VLAN) service;
a virtual private LAN service (VPLS);
a virtual private network (VPN) service; and
a virtual leased line (VLL) service.

15. A fault-management system, comprising:
a failure-identification module adapted to:
identify a first failure to receive a first connectivity check message associated with a session between the computing system and a remote device; and
generate a second connectivity check message that indicates the first failure and is destined for the remote device;
a port-suspending module adapted to, in response to identifying the first failure, suspending a first port, wherein the first port is a local port associated with the session; and
an operation-resuming module adapted to:
in response to identifying a third received connectivity check message associated with the session from the remote device, resuming operation on the suspended first port; and
generating a fourth connectivity check message that indicates a recovery from the first failure and is destined for the remote device.

16. The system of claim 15, wherein while suspending the first port, the port-suspending module is adapted to:
place the first port in a special down state; and
maintain state information for the first port.

17. The system of claim 15, wherein while identifying the failure, the failure-identification module is adapted to process a message generated by a remote switch indicating the first failure, wherein the message is a connectivity fault management message.

18. The system of claim 15, wherein the port-suspending module is further adapted to:
in response to suspending the first port, generate a plurality of second connectivity check messages that indicate the first failure and are destined for the remote device.

19. The system of claim 15, further comprising:
a remote device failure detection module adapted to identify a second failure at the remote device, wherein the second failure is associated with a second port which faces a destination node of a communication service;
a port-determining module adapted to map a third port of the computing system to the second failure, wherein the third port is a local port which faces a source node of the communication service; and
wherein the port-suspending module is further adapted to suspend the third port in response to identifying the second failure at the remote device.

20. The system of claim 19, wherein the communication service includes at least one of:
a virtual local area network (VLAN) service;
a virtual private LAN service (VPLS);
a virtual private network (VPN) service; and
a virtual leased line (VLL) service.
